(19) United States
(12) Patent Application Publication
(10) Pub. No.: US 2020/0360942 A1
(43) Pub. Date: Nov. 19, 2020

(54) POWDER SPRAYING HEAD AND POWDER COATING INSTALLATION WITH SUCH

(71) Applicant: Soudronic AG, Bergdietikon (CH)

(72) Inventors: André Saiu, Bergdietikon (CH); Pascal Gauch, Bergdietikon (CH); Peter Taina, Bergdietikon (CH)

(21) Appl. No.: 16/497,625

(22) PCT Filed: Dec. 14, 2017
(86) PCT No.: PCT/CH2017/000103

§ 371 Date: Sep. 25, 2019

(30) Foreign Application Priority Data
Mar. 30, 2017 (CH) 430/17

(51) Int. Cl. B05B 5/053; B05B 1/26; B05B 5/08; B05B 5/12; B05B 13/06; B05D 1/06; B21D 51/26

(52) U.S. Cl. CPC B05B 5/0533; B05B 1/267; B05B 5/081; B21D 51/2676; B05B 13/0618; B05D 1/06; B05B 5/12

(57) ABSTRACT

A powder spraying head for spraying a powder on a can body to be coated comprises a work chamber inside the powder spraying head, a powder tube for providing the powder, a charging electrode for charging the powder with an electrostatic charge and a guiding electrode for deflecting the powder present inside the work chamber substantially in the direction of the work opening. The charging electrode is arranged in the area of the powder outlet and is formed with a tip in the direction of the powder streaming into the work chamber. Additionally or alternatively, the guiding electrode is plate-shaped and a flat side of the guiding electrode is oriented towards the work chamber.

### CROSS REFERENCE TO RELATED APPLICATIONS

This application is a National Stage application of International Patent Application No. PCT/CH2017/000103, filed Dec. 14, 2017 which claims the priority of Swiss patent application 0430/17, filed Mar. 30, 2017, the disclosure of which is incorporated herein by reference in its entirety.

### TECHNICAL FIELD OF THE INVENTION

The invention relates to a powder spraying head for spraying a coating powder and a powder coating installation for coating a can body with powder according to the preambles of the independent claims.

### BACKGROUND OF THE INVENTION

Powder coating installations with powder spraying heads for coating can bodies are known. Such powder spraying heads are substantially rod-shaped and have such an outer diameter that a previously welded can body can surround them and be transported along the powder spraying head in a transport direction. During this translatory movement, at least a part of the inner surface of the can body is coated with powder. Particularly, in this way the welding seam of the can body is coated for protecting it against corrosion.

The coating with powder is performed based on electrostatic charge of the powder particles. For this, a charging electrode is used, which has a negative high voltage with respect to the can body being at ground potential. Due to the electrostatic charge of the powder particles, they are deflected in the direction of the can body and adhere thereto. In order to additionally support this deflection in direction of the can body, a further so-called guiding electrode is used, which is also charged with a negative voltage. Hence, the already negatively charged powder particles are pushed away by the negatively charged guiding electrode, thereby additionally supporting the deflection of the powder towards the can body.

A known powder coating installation made by the company Soudronic of Bergdietikon, Switzerland comprises amongst others a powder spraying head for which the charging electrode and the guiding electrode are implemented as an electrode block.

### SUMMARY

The objective of the invention is to provide a powder spraying head and a powder coating installation, which makes possible an improved adhesion of the powder to the can body.

This objective is reached by a powder spraying head and a powder coating installation according to the independent claims.

According to this, a powder spraying head according to the invention for spraying a powder suitable for coating a can body is provided, wherein the powder spraying head is adapted in such a way that the can body to be coated encloses the powder spraying head and is movable along the powder spraying head in a transport direction for coating at least a part of an inner surface of the can body. The powder spraying head comprises inside a work chamber which has a work opening through which the powder can reach the inner surface of the can body. Furthermore, it comprises a powder tube for providing the powder, wherein the powder tube with a powder outlet leads to the work chamber of the powder spraying head. The powder tube is adapted to deliver the powder substantially in transport direction into the work chamber. Furthermore, it comprises a charging electrode for charging the powder with an electrostatic charge, and a guiding electrode which is arranged in transport direction downstream of the charging electrode and below the work chamber for deflecting the powder present inside the work chamber, which is already electrostatically charged, substantially in the direction of the work opening. The guiding electrode and the charging electrode have a same polarity.

The charging electrode is arranged in the area of the powder outlet and is formed with a tip on the powder side (in the direction of the powder streaming out of the powder outlet). Due to the arrangement at the powder outlet, where the powder enters the work chamber, it is reached that the influence of the electric field on the powder streaming into the work chamber is increased. Furthermore, the pointed shape of the charging electrode causes a “concentration” of the electric field at the location where the powder streams through the powder outlet. These measures cause an increase of the electrostatic charge of the powder, such that it experiences a stronger deflection in direction of the work opening after entering the work space.

Additionally or alternatively to this, the guiding electrode is plate-shaped and a flat side of the guiding electrode is oriented towards the work chamber. This construction and orientation of the guiding electrode allows a better capture of the powder located inside the work space by the corresponding electric field of the guiding electrode. Due to the plate-shaped construction of the electrode, a more homogenous electric field with substantially parallel field lines, similarly to a plate capacitor, is generated inside the work chamber, which causes an as uniform as possible deflection of the powder away from the guiding electrode and towards the can body.

Consequently, the designs of the charging electrode and of the guiding electrode cause in interaction but also each one for itself an improved deflection of the powder in the desired direction. In this way, the powder can be guided more efficiently to the can body. The stronger electrostatic charge of the powder, which depends on the special arrangement and shape of the charging electrode, is however not only relevant for the deflection of the powder, but it also causes that the powder adheres better to the can body, in other words the deposition efficiency is higher. Due to this, a can body of higher quality is produced, which is even more resistant against outer influences, e.g. corrosion, due to the later content of the can. Additionally, the powder is charged uniformly independently from the particle size.

Preferably, the guiding electrode has such a first distance from the charging electrode in transport direction that the electric field of the guiding electrode acts upon the powder, which is electrostatically charged by the charging electrode, immediately after the powder enters the work chamber. This arrangement of the guiding electrode has the advantage that no or only a minimal portion of the powder particles can stream in another direction than towards the can body.

The powder coating installation according to the invention, for coating the can body with powder, comprises a powder spraying head according to the invention. It further comprises a powder transport device for supplying the powder spraying head with powder. The powder transport device is connectable to the powder tube for providing the powder. Finally, the powder coating installation comprises a powder recycling unit for sucking the excess powder which is generated during the coating. The powder recycling unit is arranged in transport direction downstream of one or more suction nozzles of the powder spraying head.

Besides the already mentioned advantages of the powder spraying head, the powder coating installation hat the further advantage that the powder recycling unit can “collect” excess powder again, such that powder is saved.

Advantageously, the powder coating installation according to the invention is used for coating a welding seam of the can body.

In one embodiment, the powder spraying head has in the work chamber at least a blade for guiding the electrostatically charged powder through the work opening to the part to coat of the inner surface of the can body. In this way, the powder can be guided even better towards the work opening.

Preferably, multiple blades are provided, which are arranged inside the work chamber in succession in transport direction in order to capture as many particles as possible. It is further preferred that the blade or the blades are bent in direction of the work opening. Preferably, in case multiple blades are present, they have an increasing acting surface in transport direction for deflecting the electrostatically charged powder. This is a further measure for capturing as many powder particles as possible, because the powder beam is more concentrated when it enters the work chamber and expands while travelling further. Consequently, the ever-wider blades in transport direction account for this scattering.

### BRIEF DESCRIPTION OF THE DRAWINGS

Further embodiments, advantages and applications of the invention result from the dependent claims and from the now following description by the drawings. It is shown in:

FIG. 1 a perspective view of a powder coating installation according to the invention with a powder spraying head according to the invention,

FIG. 2 a detailed view of a part A of the powder spraying head of FIG. 1 in a section view,

FIG. 3 a lateral section view of the detail of FIG. 2, and

FIG. 4 a cross-sectional view of the powder spraying head, as seen in direction B of FIG. 3.

### DESCRIPTION OF THE PREFERRED EMBODIMENTS

### Definitions and Notes

In the present context, the term “plate-shaped” is understood as a flat piece of a hard material, in this case metal, which has the same thickness allover and which is limited on each two opposite sides by an even surface which is very large as compared to the thickness.

The term “suitable” in the context of powder defines any powder which the skilled person would use for coating metal surfaces.

The term “transport direction” refers to a transport direction of the can bodies and is denoted by the arrow z, which at the same time also denotes the longitudinal axis of the powder spraying head.

A “work chamber” denotes a cavity in the powder spraying head, inside which the powder is deflected towards the can body.

The term “electrically neutral” refers in this context to a material which is neither charged or chargeable electrically positively nor electrically negatively.

The terms “axial” and “radial” relate to a cylindrical coordinate system with the axis z. Accordingly, the term “front” relates to the direction of arrow z and “rear” to the opposite direction. The terms “bottom” and “top” refer to the direction of the gravitational force.

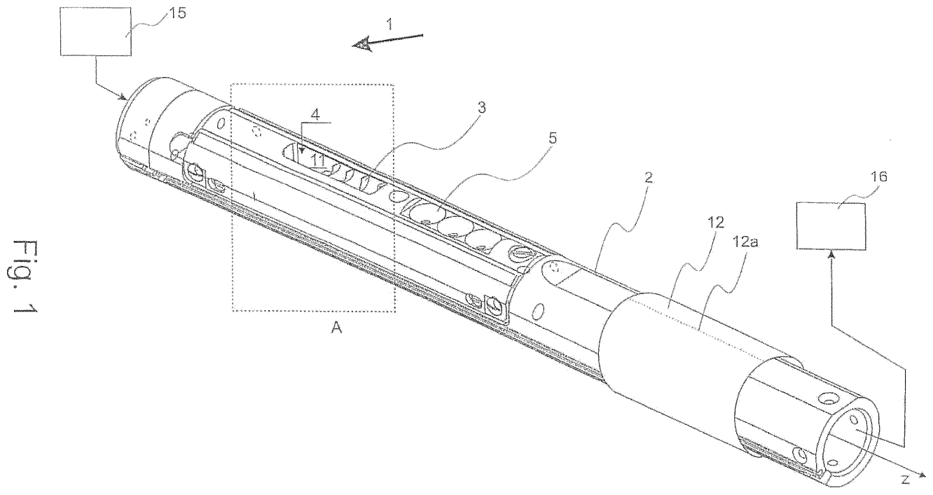

FIG. 1 shows a powder coating installation 1 according to the invention with a powder spraying head 2 according to the invention in perspective view. Furthermore, the powder coating installation 1 comprises a powder transport device 15 for supplying the powder spraying head 2 with powder, and a powder recycling unit 16, which sucks excess powder out of the powder spraying head 2. Furthermore, a work opening of the powder spraying head 2 is denoted by arrow 4, through which the powder can reach a can body 12 out of the work chamber 11. Furthermore, blades 3 are arranged inside the work chamber 11. Three suction nozzles 5 are arranged downstream of the work space 4. In the following, these elements are described in detail in the context of the powder spraying head 2. Additionally, FIG. 1 shows the can body 12 in a position where its welded longitudinal seam 12a is already coated, wherein the coating was performed on the inner surface of the can body and is therefore not visible in the figure.

The powder coating installation 1 of FIG. 1 further comprises a controller (not shown) by means of which amongst others the aforementioned variables are adjusted or monitored, respectively. Hence, the controller is connected to the powder spraying head 2, the powder transport device 15 and the powder recycling unit 16.

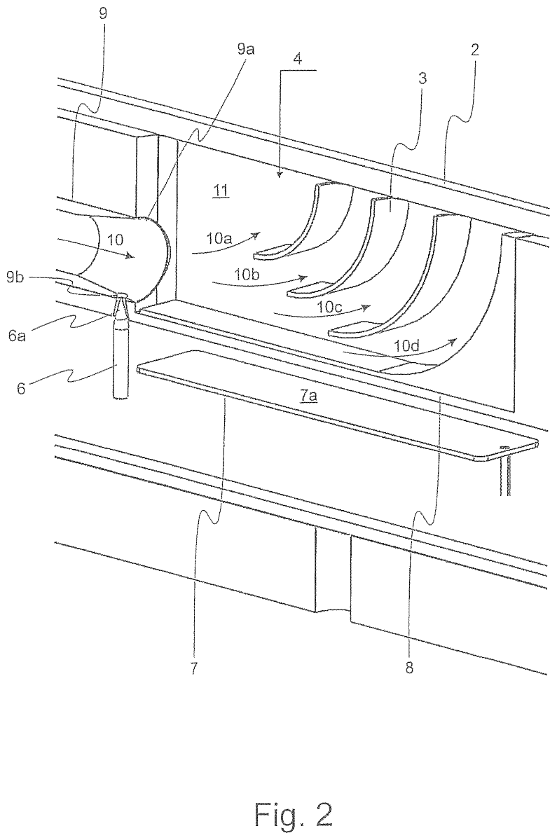

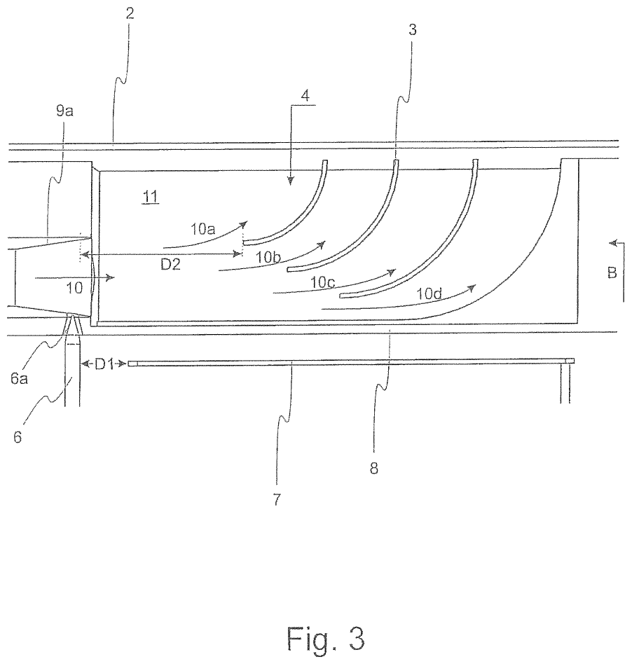

FIG. 2 shows a detailed view of a part A of the powder spraying head 2 of FIG. 1 in sectional view and FIG. 3 shows a lateral sectional view of the detail of FIG. 2.

In the figures, the way of the powder is shown schematically by means of the arrows 10, 10a-d.

A part of the powder tube 9 which ends with a powder outlet 9a is shown left in the figures. The powder outlet 9a, which is manufactured of an electrically neutral material, like the powder tube 9, is the exit of the tube 9 into a work chamber 11. Preferably, the powder outlet 9a extends in transport direction z in a conically expanding way. In this way, a better distribution of the powder in the work space is reached.

The charging electrode 6 is arranged in the area of the powder outlet 9a and extends on the powder side in a tip-shaped way with a tip 6a. The charging electrode 6 is arranged below the powder outlet 9a. However, it could also be arranged more to the front in z-direction in direction of the work space 11 or more to the rear side, which is emphasized by the term “in the area of the powder outlet”. It is preferably rod-shaped and its longitudinal axis is perpendicular to the transport direction z. Preferably, the charging electrode extends with its tip through an opening in a wall of the powder outlet 9a substantially up to an inner surface of the powder outlet 9a. In this way it is reached that the charging electrode is arranged as close as possible to the powder. The location of the charging electrode 6 and particularly the tip shape make it possible to reach a higher electrostatic charge of the powder when it enters the work chamber 11. As already mentioned, the tip shape of the charging electrode 6 at its upper extremity means a concentration of the corresponding electric field on a small area inside the powder outlet 9a. The result is that the passing powder can be charged electrostatically in a more effective way, due to the stronger electric field, during the short time while it passes by the charging electrode.

Furthermore, the powder spraying head 2 comprises a guiding electrode 7 which is plate-shaped. A flat side 7a of the guiding electrode is oriented towards the work chamber. Due to the flat shape of the guiding electrode 7 it is reached that a second electric field is generated, which has a much larger extension than the electric field of the charging electrode 6. The orientation of the charging electrode 7 (surface 7a) causes that the electric field lines run in such a way that the already electrically negatively charged powder is repelled inside the work chamber 11 from the guiding electrode 7, which is also negatively charged. The guiding electrode 7 may however also be formed by multiple pieces, particularly by multiple strips. A slightly convex or concave shape is also conceivable, as long as the side 7a of the guiding electrode, which faces the work space, has a large extension. In this way, an upward deflection of the powder in direction of the work opening 4 is reached. Consequently, during the flight through the work chamber 11 a powder particle has on the one hand a speed component substantially in (axial) transport direction z, which is prescribed by the powder transport device 15. Due to simplicity reasons, a deviation due to a radial scattering of the powder is negligible here. On the other hand, the powder particle has a speed component in radial direction (thus perpendicular to the direction z), which is caused by the electric field of the guiding electrode 7. The resulting direction vector of the powder particle therefore depends on the influx speed into the work chamber 11, the electrostatic charge by the charging electrode 6 and the strength of the electric field of the guiding electrode 7. A further factor is the particle size of the powder particle. This size is however not taken into account in the present context, because the use of a conventional standard powder is assumed. The aforementioned variables are rather varied in order to account for the particle size (and hence mass) of the powder. The choice of a different particle size for the powder is however also conceivable.

The guiding electrode 7 has in transport direction such a first axial distance D1 (FIG. 3) from the charging electrode 6 that the electric field of the guiding electrode 7 acts upon the powder charged electrostatically by the charging electrode 6 immediately after the powder enters the work chamber 11. In this way it is avoided that powder particles get a downward speed component and may potentially fall on the bottom of the work chamber 11, which is undesired. The axial distance D1 depends on the aforementioned factors (influx speed into the work chamber 11, electrostatic charge and strength of the electric field of the guiding electrode 7). It is conceivable (not shown) that the guiding electrode 7 is adapted to be shiftable in z-direction, in order to have an additional degree of freedom in case of variation of the aforementioned parameters. By choosing the axial distance D1 in a suitable way, it is consequently reached that the powder particles are “taken over” by the electric field of the guiding electrode 7 immediately after they enter the work chamber 11 and consequently experience immediately an upward deflection.

The guiding electrode 7 is arranged outside the work chamber 11 and is preferably separated from it at least by an isolator 8. In this way it is avoided that the guiding electrode 7 in time is coated with a powder layer due to the “dirty” work environment. This may e.g. occur due to turbulences or particularly when the electric field of the guiding electrode 7 is switched off, because the powder particles which are still flying inside the work chamber at this instant don't experience a force compensating their own gravitational force anymore and consequently fall down. A layer formed in this way would change the electric properties of the guiding electrode 7 by forming a dielectric powder layer, which is undesired.

Preferably, the guiding electrode 7 has a greater distance to the longitudinal axis z of the powder spraying head 2 than the tip 6a of the charging electrode 6. This measure serves to avoid a negative influence on the electric field of the charging electrode (corona-effect), because the powder particles are otherwise not charged. The tip of the charging electrode has to be as free as possible from other electric fields.

The guiding electrode 7 extends preferably beyond the end of the work chamber 11 in transport direction z. In this way it is made sure that the entire powder along the entire longitudinal extension of the work chamber 11 (and particularly of the work opening 4) is captured by the electric field of the guiding electrode 7. This is described in more detail in the context of blades 3 of the powder spraying head 2.

Three blades 3 for guiding the electrostatically charged powder through the work opening 4 to the part of the inner surface to be coated of the can body 12. The blades 3 are manufactured with an electrically neutral material and are arranged in the work chamber 11 one after the other in transport direction z. As can be seen in the figures, the powder is deflected upward (arrows 10a-d) by the blades 3. Their task is therefore to support the deflection of the powder. The number of blades 3 takes into account the fact that not all powder particles fly in transport direction z with the same speed and consequently their deflection also occurs in different ways. The different speed of the powder particles depends on the one hand on collision of powder particles in the powder stream, resulting in a change of their speed. On the other hand, the powder stream is scattered when exiting the powder outlet, such that the powder particles get different axial components of the speed. Finally, the varying mass of the powder particles also plays a role. Due to these reasons, some powder particles travel a longer distance than other particles inside the work chamber. This is the reason why the guiding electrode 7 extends preferably up to the end of the work chamber 11.

For an efficient deflection, the blades 3 are curved in the direction of the work opening 4, in order to make possible an as laminar as possible flux of the powder past them. A laminar flux is in general desired for ensuring an as uniform as possible powder coating onto the inner surface of the can body 12. In this way it is avoided that the time for the particles to travel the distance is not prolonged by potential turbulences, while for other particles there is no such delay. It is noted that in view of this the shape of the work chamber 11 may also be designed in a different way than in the exemplary embodiments. In this context one can also recognize from FIGS. 2 and 3 that the front wall of the work chamber 11 (at arrow 10d) has a same or similar shape in transport direction z like the blades 3.

If multiple blades are present, they preferably have an ever increasing action surface for the deflection of the electrostatically charged powder in transport direction z. This is due to the fact that because of the physically caused scattering of the powder stream, this powder stream is wider at the foremost blade 3 (at arrow 10c) than at the rearmost blade 3 (at arrow 10a). Due to this, the surface variation also causes an effective deflection at the front (in transport direction z).

Preferably, the blades 3 have in transport direction z a second axial distance D2 from the charging electrode 6, which is greater than the first distance D1. The second axial distance D2 is understood as the distance from a starting point of a first blade 3, which is closest to the charging electrode 6, to a z-position of the charging electrode 6. This measure is applied due to the fact that the powder arrives “in stages” inside the work chamber 11 for construction reasons. This means that the powder stream doesn't have a constant density over time but the density curve is sinusoidal. Such a development would also cause the coating to be wave-shaped, i.e. with thicker and thinner sections, which is undesired. The work chamber 11 causes in the “wide” space up to the blades that the density of the powder stream gets uniform to a certain extent, such that it arrives at the can body 12 with an as uniform as possible density.

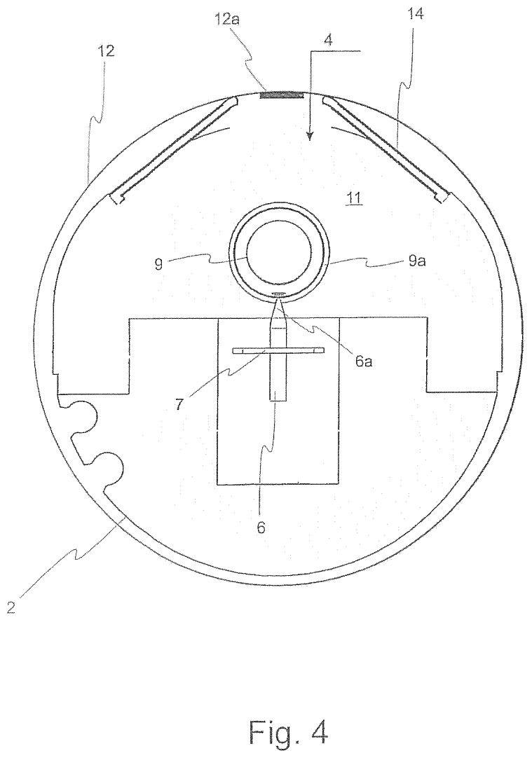

FIG. 4 shows a cross-sectional view of the powder spraying head 2, as seen in direction B of FIG. 3, i.e. opposite of the transport direction z of the can body 12. In this figure, two sealing lips 14 are shown, which were not drawn in the previous figures due to clarity reasons. These sealing lips 14 are attached to a contour of the work opening 4. It is possible to have one sealing lip or more sealing lips. A free end of the sealing lip 14 lies on the inner wall of the can body 12, when it is present, such that only the part to be coated of the inner wall of the can body 12 can come into contact with the powder. In this example, the coating shall be applied on the welding seam 12a as corrosion protection, as mentioned at the beginning. Because this welding seam 12a extends in longitudinal direction z of the can body 12, the work opening 4 is correspondingly designed slit-shaped in order to only expose the area of the welding seam 12a. When a can body 12 is present above the work opening 4, the sealing lips 14 snug at the inner wall of the can body 12 laterally to the welding seam, such that no coating powder can get to other sections of the inner wall and consequently only the desired area is coated.

Certainly, the work opening 4 and/or the sealing lips 14 can have another shape, depending on what has to be coated. Accordingly, the shape and extension of the guiding electrode may vary according to the shape of the work opening 4.

Finally, the powder spraying head 2 comprises a high voltage generator (not shown), which is adapted for generating a negative voltage which can be regulated in a range from 8 to 40 kV between the charging electrode 6 and the grounded can body 12. The generator can additionally be adapted to generate a negative voltage, which can be regulated in a range from 8 to 40 kV, between the guiding electrode 7 and the grounded can body 12. Alternatively, two different generators can be used.

While presently preferred embodiments of the invention are shown and described in this document, it is distinctly understood that the invention is not limited thereto but may be embodied and practiced in other ways within the scope of the following claims. Therefore, terms like “preferred” or “in particular” or “particularly” or “advantageously”, etc. signify optional and exemplary embodiments only.

What is claimed is:

1. A powder spraying head for spraying a powder which is suitable for coating a can body, wherein the powder spraying head is adapted in such a way that the can body to be coated encloses the powder spraying head and is movable along the powder spraying head in a transport direction (z), for coating at least a part of an inner surface of the can body, comprising
a work chamber inside the powder spraying head, which has a work opening through which the powder can reach the inner surface of the can body,
a powder tube for providing the powder, wherein the powder tube with a powder outlet opens into the work chamber of the powder spraying head and is adapted to deliver the powder substantially in transport direction (z) into the work chamber,
a charging electrode for charging the powder with an electrostatic charge,
a guiding electrode, which is arranged in transport direction (z) downstream of the charging electrode and below the work chamber, for deflecting the powder present inside the work chamber, which is already electrostatically charged, substantially in the direction of the work opening, wherein the guiding electrode and the charging electrode have a same polarity,
wherein the charging electrode is arranged in the area of the powder outlet and is formed with a tip in the direction of the powder streaming into the work chamber and/or
wherein the guiding electrode is plate-shaped and a flat side of the guiding electrode is oriented towards the work chamber.

2. The powder spraying head according to claim 1, wherein the charging electrode is rod-shaped and its longitudinal axis is perpendicular to the transport direction (z).

3. The powder spraying head according to claim 1, wherein the charging electrode extends with its tip through an opening in a wall of the powder outlet substantially up to an inner surface of the powder outlet.

4. The powder spraying head according to claim 1, wherein the guiding electrode extends at least up to an end of the work chamber in transport direction (z).

5. The powder spraying head according to claim 1, wherein the guiding electrode is formed by multiple parts, particularly by multiple strips.

6. The powder spraying head according to claim 1, wherein the guiding electrode is arranged outside the work chamber and is particularly separated from it by at least an isolator.

7. The powder spraying head according to claim 1, wherein the guiding electrode is arranged at a greater distance to the longitudinal axis (z) of the powder spraying head than the tip of the charging electrode.

8. The powder spraying head according to claim 1, wherein the guiding electrode has such a first axial distance (D1) from the charging electrode in transport direction (z), that the electric field of the guiding electrode acts upon the powder, which is electrostatically charged by the charging electrode immediately after the powder enters the work chamber.

9. The powder spraying head according to claim 1, wherein at least a blade for guiding the electrostatically charged powder through the work opening to the part to coat of the inner surface of the can body is provided inside the work chamber, particularly wherein multiple blades are provided, which are arranged inside the work chamber in succession in transport direction (z), particularly wherein the blade or the blades are curved in direction of the work opening, particularly wherein in case multiple blades are present they have an increasing acting surface in transport direction (z) for deflecting the electrostatically charged powder.

10. The powder spraying head according to claim 8, wherein the blade or the blades have a second axial distance (D2) from the charging electrode in transport direction (z), which is greater than the first distance (D1).

11. The powder spraying head according to claim 1, wherein the powder outlet extends in transport direction (z) in a conically expanding way.

12. The powder spraying head according to claim 1, further comprising a high voltage generator which is adapted to generate a negative voltage, which can be regulated in a range from 8 to 40 kV, between the charging electrode and the grounded can body and/or which is adapted to generate a negative voltage, which can be regulated in a range from 8 to 40 kV, between the guiding electrode and the grounded can body.

13. The powder spraying head according to claim 1, wherein at least a sealing lip is attached to a contour of the work opening, wherein a free end of the sealing lip snugs to the inner surface of the can body when a can body is present, such that only the part to be coated of the inner wall can come into contact with the powder.

14. The powder spraying head according to claim 1, further comprising at least a suction nozzle for the excess powder, particularly wherein multiple, particularly three, suction nozzles are arranged in succession in transport direction (z).

15. A powder coating installation for coating a can body with powder, with a powder spraying head according to claim 1, further comprising
a powder transport device for supplying the powder spraying head with powder, wherein the powder transport device is connectable to the powder tube for providing the powder, and
a powder recycling unit for sucking the excess powder which is generated during the coating, wherein the powder recycling unit is arranged in transport direction (z) downstream of one or more suction nozzles of the powder spraying head.

16. Use of the powder coating installation according to claim 15 for coating a welding seam of the can body.
